(19) United States
(12) Patent Application Publication
(10) Pub. No.: US 2010/0059454 A1
(43) Pub. Date: Mar. 11, 2010

(54) Method for clean-up of an underground plume contaminated with hydrocarbon leakage, and the like

(75) Inventors: Nima Kabir, Orange, CA (US); Lilyanna Perez, Orange, CA (US); Yones Kabir, Orange, CA (US)

Correspondence Address: Nima Kabir, # A,, 645 N. Eckhoff Ave., Orange, CA, 92868, US

(73) Assignee: Q ENVIRONMENTAL, INC.

(21) Appl. No.: 12/283,003

(22) Filed: Sep. 8, 2008

(51) Int. Cl. C02F 1/00

(52) U.S. Cl. 210/749; 166/52; 166/69; 210/747; 210/170.07; 210/759

(57) ABSTRACT

An underground plume of water and soil which has been contaminated typically by H2S and/or hydrocarbon leakage from underground fuel containers is mitigated by a process of injecting a combination of colloids, peroxides and enzymes. This is accomplished by obtaining core samples to determine the extent of contamination thereby defining the perimeter of the plume, and drilling a series of injection well sites on a pavement or other surface to mitigate the leakage. In a first stage of mitigation, a colloid containing micelles is pressured into the injection wells, the colloid functioning to neutralize hydrocarbons, MTBE, solvents, and similar compounds, thereby mitigating the plume contamination. In a second stage, if mitigation of the plume contamination proves insufficient using colloid treatment, peroxides are then pressured into the injection wells. Typical peroxides could include hydrogen peroxide and various other peroxides. In a third stage of mitigation if necessary, enzymes are utilized for pressurization into the injection sites to digest the remnants of the contamination.

### BACKGROUND OF THE INVENTION

This invention relates to a new and improved method and apparatus for mitigating contamination of underground and surface areas due to leakage from storage tanks, car washes, waste disposal dumps, refinery pipes, oil wells, and the like.

The contamination of underground areas represents a serious problem since the source of leakage generally produces a plume of contamination which may affect the ground water supply that in turn could affect a drinking water supply if the plume is not sufficiently diluted. Typically, the contaminations arise due to H2S and/or hydrocarbon leakage from underground fuel containers and which may contain undesirable components such as MTBE (methyl-t-butyl-ether; CH3-O-t-butyl). Additionally as indicated, open storage dumps holding toxic wastes are notorious for leakage into adjacent soil areas.

Consequently, various attempts have been proposed for site treatments to neutralize the effects of contaminated plumes, and include removal of the contaminated soil followed by containerization, and neutralizing the contaminated areas by a combination of treatment components, and the like. The problem with many of these techniques is that removing contaminated soil, containerization and then transporting the containers to a new disposal site can be expensive. Also, neutralization of contaminated areas may be initially effective, but in the long term, leakage from the contaminated plume can migrate out and result in cross-contamination.

Typical patents in the area of this invention include: U.S. Pat. Nos. 4,435,292; 5,120,160; 5,525,008; 5,789,649; 6,250,846; 6,558,081; 7,175,770; 2001/0002970; 2003/0037924; and, 2007/0137894.

Hence, it is important that when a contaminated site is neutralized, it will remain mitigated for a long period of time, and in an inactive state, will continue to remove further contaminants which may migrate from the plume area.

### THE INVENTION

According to the invention, a method and apparatus is provided for neutralizing both an underground plume and surface contaminated areas. In the case of a contaminated underground plume, the method involves the initial steps of obtaining a sufficient number of core samples to identify the boundaries or perimeter of the plume. When the plume has been defined, a series of injection wells are formed into which are inserted perforated plastic piping such as 1.5-2 inch diameter PVC in the vicinity of a suspected area of contamination. Typically, a suspected area may be located near a fuel storage tank, car wash, etc.

Following the initial steps of obtaining core samples, these samples are then analyzed to obtain the nature of the contamination. This in turn will determine the type of treatment solutions to be applied to an area of the plume, and may involve a single treatment or varying treatments for different areas of the contaminated plume. The conductivity of the contaminated water will determine the amount and nature of the treatment solutions to be used.

A sufficient number of injection wells about 5-20 feet apart are installed to a minimum of 10 feet below groundwater level. To control the expansion of the plume and to control the diffused border of a secondary plume, additional injection points can be installed at about 20 foot intervals for approximately 200 feet outside these known plume limits.

Finally, treatment solutions are injected into injection wells to interact and mitigate contaminated portions of the plume. To better assess the progress of the mitigation process, soil-gas and/or water samples are removed periodically from a series of network wells for analysis during projected reaction times, about 30 days.

Initially, if the mitigation required is of a type which can be addressed by injecting a colloid which can dissolve or neutralize hydrocarbon leakage, this would be the simplest form of neutralization. A preferred colloid treatment involves using ionized sub-microscopic particles called micelles approximately 10-6 cms. In length. The polar nature of each micelle produces an opposite charge at either end, one end being hydrophobic, the other end hydrophilic. The micelles react and disperse contaminating hydrocarbons into individual particles that do not redeposit; hence, the hydrocarbon is neutralized. Other contaminants such as MTBE can be removed by this process. An ECO REMEDIATION solution containing a colloid cleaner and degreaser is a relatively low cost option for use in colloid treatment, and since it is non toxic and biodegradable, it is a preferred type of colloid. Surfactant systems are disclosed in the publication by EPA, entitled: “in Situ Enhanced Source Removal”, published September 1999 in EPA/600/C-99/002.

For a fundamental understanding of the mechanism behind micelle remediant products that provide commercial “lock and key” molecular recognition, sequestering and ligand properties (a form of “Nano Technology”), it is a special application of Supra-molecular chemistry. However, the subject has evolved into a highly interdisciplinary field that spans molecular physical chemistry (hydrogen bond forces, van der Waals forces, pi-pi interactions, metal coordination, hydrophobic, hydrophilic, electrostatic and ionic field effects, etc.), interactive (non-covalent) inorganic/organic chemistry, thermodynamics, dynamic covalent chemistry, mono and macro molecular interfacial dynamics and biometric behavior. Quantum, resonance and wave physics, particularly during dynamic and static states of equilibrium, unlike covalent bond chemistry, can play an important roll in understanding the dynamic behavior of amphipathic molecular aggregates exhibited at or beyond its critical micelle concentrations in aqueous solvent colloidal systems.

In commercial applications, micellation involves the classic self-assemblage of amphipathic molecular aggregates, by the uses of lipid formulation and processes at their critical micelle concentrations, in an aqueous solution. Whereby, dichotic hydrophobic amphiphiles—in the case of spherical, ellipsoid disc and rod conglomerates—are formed with their hydrophilic heads that pose a crystal-like, densely patterned, outermost polar charge distributed, permeable membrane outer surface, which interfaces with local-zone polar water molecules and ions (an aqueous solvent solution) in an inverse (mirrored) charge distribution pattern.

Due to a balanced state of equilibrium between Brownian motion and van der Waals forces—at defined resonance—particularly at a zero point interface, a neutral patterned Casimir effect shear-plane interfacial “bubble” of approximately 0.009 pm thickness and (patterned interactive Casimir virtual space) having unique “lock and key” physical properties, can be arguably said to ubiquitously coexist about each micelle.

Similarly, at the central locus zone of a micelle can be said to be a local Casimir effect zero-point (akin to a hole in space) about which the hydrophobic tails of discotic amphiphiles are oriented by hydrogen bond van der Waals force affinities.

Due to a gradient field interaction between the inner zero-point hole and the outer shear-plane bubble of the micelle, held in statis by organized discotic amphiphiles, hydrogen bonds and van der Waals forces set up a characterized external electric field and virtual patterned clustered water with static and dynamic molecular recognition properties that (the combination) exhibit a natural affinity and attraction for reciprocal polarized non-covalent bound molecules or appendages, typically within 28 to 35 micelle diameters. Since typical micelle sizes range between 19 Angstroms to 30 Angstroms, typical effective molecular capture field ranges between 540 Angstroms and 0.11 nm.

Non-covalent molecules that drift into this field will tend to be captured and drawn to and stretched across the topologically patterned shear plane at the outer surface of the micelle due to electric, van der Walls and other forces. Whereupon, the bonding forces between the polar ends of the now distended molecule are weakened. Whereby, the molecule is further drawn apart (differentiated mechanically) by “lock and key” entropic endothermic catalysis, partially into the slipstream channels of the micelle—somewhat analogous to the drift action of HPLC. After which differentiated ions may chemically recombine into simpler benign byproducts due to the benign (often endothermic) catalysis nature of the amphipathic lipid components. Brownian motion will then tend to cause the destabilized micelle involved to dismantle and biodegrade through bacterial activity or chemically recombine (initiated by van der Waals forces) with dissolved oxygen into water soluble compounds and gases such as CO2, H2O, fertilizer nitrates, N2 and H2O2.

For example, in the case of H2S, the sulfur tends to be sequestered toward the center of a rod micelle in a lock and key action, while the hydrogen ion will remain at the outer shear plain and recombine with dissolved oxygen in its aqueous vicinity to form water.

Hence, the sequestered sulfur will drip out as elemental sulfur or can more likely chemically reform into say for instance, an amino acid like methionine and/or cysteine, depending on the amphipathic lipid compound. Brownian motion will then to cause the destabilized micelle involved to dismantle and biodegrade through bacterial activity or chemically recombine (initiated by van der Waals forces) with dissolved oxygen into water soluble compounds and gases like CO2, H2O, fertilizing nitrates, N2 and H2O2.

In the special case of macrocyclic compounds that are circular, and have a greater lock and key affinity with spherical micelles, they will stretch apart along the virtual patterned shear plane and extend out to the micelle's circumference. After which the components will tend to chemically recombine into simpler benign by products, due to the benign (entropic and often endothermic) catalysis nature of amphipathic lipid components. Brownian motion alone will tend to cause the destabilized micelle involved to dismantle and biodegrade through bacterial activity or chemically recombine (initiated by van de Waals forces) with dissolved oxygen and water soluble compounds and gases like CO2, H2O, fertilizing nitrates, N2 and H2O2.

If mitigation with colloids does not provide the required mitigation, the addition of peroxides are employed. Hydrogen peroxide; potassium permanganate (KMnO4); persulfate (Na2O8S2); ozone (O3); and, peroxone (a combination of ozone and H2O2) may be used, depending on the type of contamination which has occurred, the use of H2O2 being preferred. These components can be applied by introducing them into the soil or aquifer at a contaminated site using a variety of injection and mixing equipment.

Following mitigation by colloids and peroxides, in rare cases a further injection of enzymes is made for microbial digestion of contaminant remnants at the treatment site. The above oxidizing agents are often combined with bacterial enzymes and/or multi-enzyme complex solutions to optimize converting organic compounds, such as petroleum hydrocarbons into aromatic and aliphatic hydrocarbons such as fatty acids, and further degradation into carbon dioxide and water. This treatment is also suitable to accelerate the biodegradation and natural attenuation of petroleum hydrocarbons and MTBE, MTBE compounds, and BTEX to less than non detectable levels after about 30 days of treatment, and is also effective in reducing xylene and ethylbenzene concentrations and H2S. Use of about a 5%-15% solution of one of colloid, peroxide and enzyme components is typical.

To enhance biodegradation of benzene, toluene, ethylbenzene, and toluene (collectively BTEX), groundwater is extracted from the core of the plume to agitate/disperse the treatment solution of this invention and to expedite the chemical oxidation reaction.

### BRIEF DESCRIPTION OF THE DRAWINGS

FIG. 1 is a sectional view in side elevation showing a typical injection well constructed into in a contaminated plume, and into which has been inserted a perforated pipe for removal of material for analysis and injection of treatment materials;

FIG. 2 is a perspective view of a drilling site showing the surface locations of potential injection wells;

FIG. 3 is a perspective view of a drilling site showing the surface locations of injection well networks; and,

FIG. 4 is an exploded, external view in side elevation of an injection device for removal of material for analysis and for injecting materials to reduce or eliminate contaminants from the plume. This device can also be used for soil gas sampling during the process of this invention.

### DESCRIPTION OF THE PREFERRED EMBODIMENTS

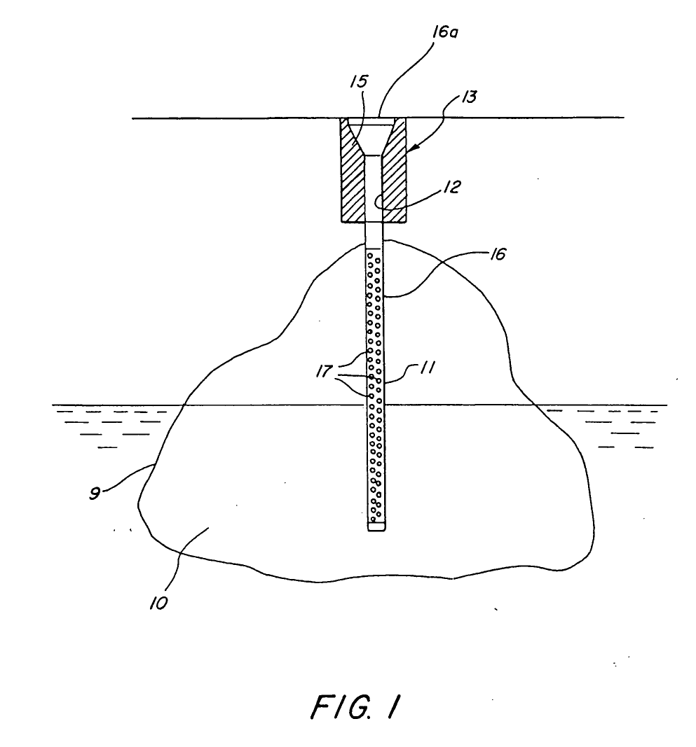

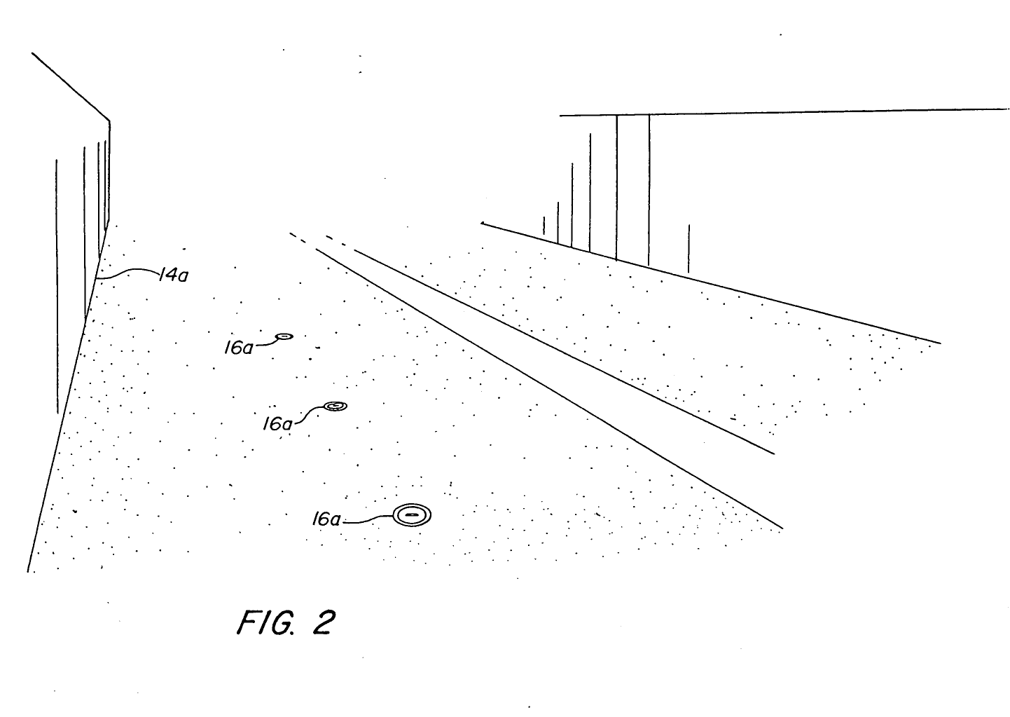

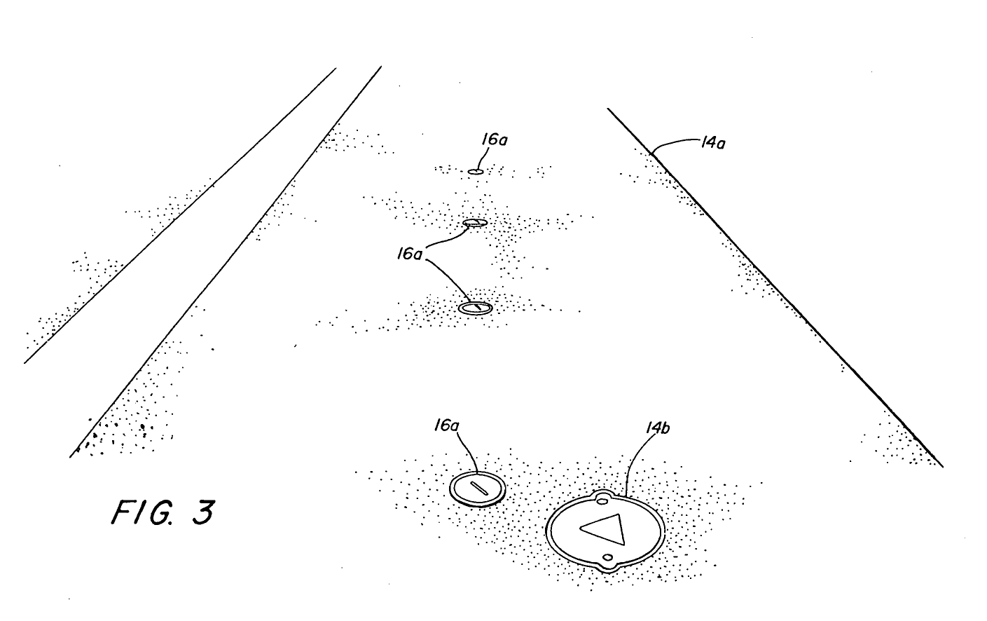

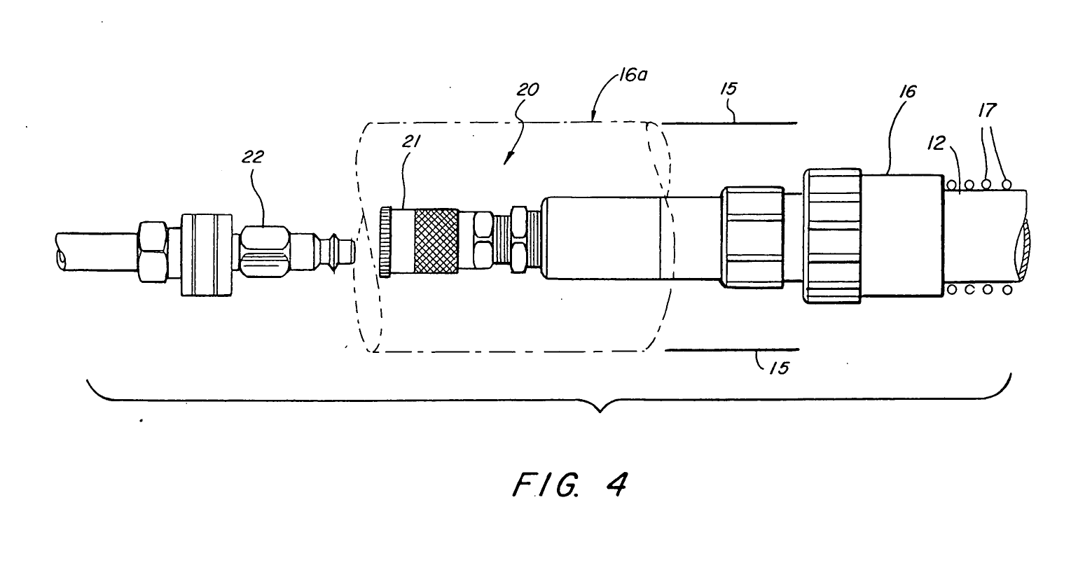

As shown in FIG. 1, the perimeter 9 of a contaminated plume 10 is shown which has migrated below ground and into an aquifer. An injection well bore 12, into which a well bore system 13 is inserted, is provided for injection of treatment solutions and to obtain soil-gas and water sample. FIGS. 2 and 3, show the surface locations of the injection wells 16 spaced along a road area 14a which are terminated by removal caps 16a. A bentonite seal 15 seals the upper end of an injection well, and in conjunction with the removal caps 16a, prevent blow-off and/or leakage from the well during use. The removal caps also function to seal off an injection well from blow-off and/or leakage during operations and allow a device (FIG. 4) to be inserted for injection of treated solutions. A sample removal port 14b (by suction pumps) is used for analysis.

A PVC pipe 11 is inserted into an injection well 16, the pipe being perforated 17 to permit the through-flow of injection and treatment solutions for the plume during operations at a treatment site. The foreground of FIGS. 2, 3 show the surface locations 16a of the injection well 16 for injecting (by pumps) to agitate and/or disperse treatment solutions into the core of the plume by means of a mobile air compressor (not shown), at about 25 psi pressure. Hence, the analysis and injection of treatment solutions possibly may provide a closed loop for an extraction (from sparger wells), enhancement, and injection system. This enables injection of treatment solutions through the perforations 17 of the PVC pipe 11.

Typical injection well depth dimensions from the surface depending on groundwater levels were found in the specific site conditions described infra, are: well depth—25 feet; total depth of casing—25 feet; depth to ground water—12-14 feet; depth to top of well screen at the top of PVC pipe—5 feet; depth to top of bentonite seal—0 feet; depth to bottom of bentonite seal—2 feet; well casing diameter—4 inches; PVC perforation 17 size—0.05 inches.

As shown in FIG. 4, an injection device 20 is provided for injection of materials into the plume through the PVC pipe 11 in order to reduce, mitigate or eliminate contaminants from the plume 10. The injection device 20 comprises a one-way coupling 21 mounted on an injection well 16 at its entry end 16a, and an injection probe 22 designed to penetrate and open the coupling. Hence, if samples are removed, or when treatment materials are injected, the one-way coupling 21 will remain open. The coupling will then close when the injection probe 22 is withdrawn from the coupling. Closure of the injection well 16 following injection of treatment material will prevent blowback from the plume 10. The perimeter of the bentonite seal 15 is shown around the entry end 16a.

The geology and hydrogeology of the area in the test program forms a Holocene & Pleistocene alluvium resting on Tertiary marine sediments, and includes perched water bearing layers. In short, a non-uniform, underlying area which is drained by sheet flow.

The site formerly included gasoline fueling facilities consisting of underground storage tanks (four 10,000 gallons), four pump islands (8 dispenser pumps), and associated piping which had been removed in June 1992. Other abandoned fuel and storage tanks are present in the area. The site itself is located at the corner of Ventura Blvd., and Capistrano Ave., Woodland Hills, Calif. Actual drilling, as shown in FIG. 2, was located along Clarendon and Delorosa streets.

Various tests indicated the test site is impacted with petroleum hydrocarbon compounds, the primary concern being fuel constituents such as benzene, toluene, ethylbenzene, xylenes and MTBE. The most probable exposure routes for the compounds are ingestion, dermal absorption through direct contact, and inhalation of vapor-phase contaminants.

Tests conducted at 30 day intervals included: Total Volatile Hydrocarbons (also referred to as Total Purgeable Hydrocarbons) using USEPA Method 8015M (water phase); Gasoline-Range organics (GRO) using USEPA Method 8015M (Soil and water phase); Volatile organic Compounds (VOCs); and Fuel oxygenates by EPA Method 8260B. Various analytical methods were employed to determine organic carbon, manganese, iron, ferrous iron, alkalinity, total dissolved solids, sulfate, chloride, boron, carbon dioxide, methane, and formaldehyde.

The water and vapor analysis data showed a significant reduction in the concentration of the most volatile fractions of the petroleum in all wells. Test results have shown that hydrocarbon concentrations were reduced to non detectable levels after 30 days of treatment.

Following a determination that no remedial action of the test site is required, the remediation and monitoring system consisting of the groundwater monitoring wells, vapor extraction wells, air sparging wells, and all conveyance piping will be destroyed according to standards described by the California Department of Water Resources.

1. A method for clean-up of an underground site contaminated with H2S and/or hydrocarbons forming a plume of soil and water, comprising the steps of defining a perimeter of the plume; digging a plurality of injection well sites in the plume; inserting a perforated pipe within an injection well; removing a soil-gas and/or water samples of the plume from the perforated pipe for analysis to determine the requirements of treatment solutions necessary to mitigate contamination of the plume; injecting the required treatment solutions into the perforated pipe; applying air pressure to agitate, disperse and interact treatment solutions within the plume; and, removing samples from the plume for further analysis to determine additional treatment solution requirements.

2. The method of claim 1, which comprises injecting treatment solutions containing a micelle containing colloid and/or a peroxide into the well sites.

3. The method of claim 1, in which the micelle containing colloid is a polar compound, the micelles having a hydrophobic and a hydrophilic end, about 10-6 cms. long, and the peroxide is H2O2.

4. The method of claim 3, including adding bacterial enzymes to assist in reducing hydrocarbon conversion.

5. The method of claim 3, which comprises about a 5%-15% solution of the micelle containing one of a colloid and H2O2.

6. The method of claim 2, in which groundwater from the plume is agitated by compressor means.

7. The method of claim 6, in which the groundwater from the plume is agitated at about 25 psi.

8. The method of claim 1, in which test samples are removed at about 30 day intervals.

9. The method of claim 1, comprising applying air pressure to agitate, disperse and interact treatment solutions within the plume, and for removing samples from the plume for further analysis to determine additional treatment solution requirements, thereby completing a closed loop, injection-treatment cycle.

10. A well site system for clean-up of an underground plume of hydrocarbon and H2S contamination, comprising a plurality if injection wells disposed within the plume; a perforated injection pipe disposed within an injection well; means to withdraw for analysis of soil-gas and/or water samples of the plume; means to inject treatment solutions to the injection pipe and dispersion through the perforations and back into the plume, and to thereby mitigate contamination of the plume; air compressor means to disperse and agitate the treatment solutions for interaction with the plume; and, sealing means disposed upwardly of an injection well to prevent blow-back from the contaminated plume during use.

11. The well site system of claim 10, comprising a plurality of adjacent wells and remote wells interconnected through the plume.

12. The well system of claim 10, in which about a plurality of injection wells about 5-20 feet apart are disposed within a contaminated plume.

13. The well system of claim 10, in which the injection wells are disposed at about 20 foot intervals outside about 200 feet from the diffused border of the plume.

14. The well site system of claim 10, including means for applying air pressure to agitate, disperse and interact treatment solutions within the plume and for removing samples from the plume for further analysis to determine additional treatment solution requirements, thereby completing a closed loop, injection-treatment cycle.

15. An injection device for insertion into an injection well disposed within a plume of contamination, comprising: a one-way coupling mounted on an injection well at its entry end, and an injection probe for penetration and opening of the coupling, whereby when treatment solutions are injected, the one-way coupling remains open, and when the injection probe is withdrawn from the coupling, it will close, thereby preventing blowback from the plume.

16. The injection device of claim 16, in which a perforated pipe is positioned within an injection well.
